(19) United States
(12) Patent Application Publication
(10) Pub. No.: US 2013/0017361 A1
(43) Pub. Date: Jan. 17, 2013

(54) MULTIWALL SHEET, METHODS OF MAKING, AND ARTICLES COMPRISING THE MULTIWALL SHEET

(71) Applicants: Chinniah Thiagarajan, Bangalore (IN); Udit Kulmi, Bangalore (IN); Santhosh Kumar Rajendran, Tamilnadu (IN)

(72) Inventors: Chinniah Thiagarajan, Bangalore (IN); Udit Kulmi, Bangalore (IN); Santhosh Kumar Rajendran, Tamilnadu (IN)

(73) Assignee: SABIC INNOVATIVE PLASTICS IP B.V., Bergen op Zoom (NL)

(21) Appl. No.: 13/180,882

(22) Filed: Jul. 12, 2011

(51) Int. Cl. B32B 5/18; E04B 1/80; B29C 47/06; B32B 3/12

(52) U.S. Cl. 428/117; 264/45.4

(57) ABSTRACT

A multiwall sheet can comprise walls, wherein the walls include: a first wall; a second wall; and a transverse wall, wherein the first wall, the second wall, and the transverse wall extend longitudinally; and a rib extending between adjacent walls, wherein a layer is formed by two adjacent walls; wherein the layer is filled with a nanoporous foam material; and wherein the multiwall sheet comprises a normalized thermal conductivity value of less than or equal to 1.00 W·m/kg·K. A method of making a multiwall sheet can comprise coextruding the multiwall sheet described above with a nanoporous foam material; wherein the layer is filled with a nanoporous foam material during coextrusion.

### BACKGROUND

The present disclosure relates generally to multiwall sheets, and more particularly to multiwall sheets having nanoporous foam material located in various layers of the multiwall sheet for use in structural and thermal insulation applications.

In the construction of naturally lit structures (e.g., greenhouses, pool enclosures, conservatories, stadiums, sunrooms, and so forth), glass has been employed in many applications as transparent structural elements, such as, windows, facings, and roofs. However, polymer sheeting is replacing glass in many applications due to several notable benefits.

One benefit of polymer sheeting is that it exhibits excellent impact resistance compared to glass. This in turn reduces maintenance costs in applications wherein occasional breakage caused by vandalism, hail, contraction/expansion, and so forth, is encountered. Another benefit of polymer sheeting is a significant reduction in weight compared to glass. This makes polymer sheeting easier to install than glass and reduces the load-bearing requirements of the structure on which they are installed.

In addition to these benefits, one of the most significant advantages of polymer sheeting is that it provides improved insulative properties compared to glass. This characteristic significantly affects the overall market acceptance of polymer sheeting as consumers desire structural elements with improved efficiency to reduce heating and/or cooling costs. It is difficult to design multiwall sheets with a low thermal transmittance value (U) because for a given thickness, the air thermal conductivity reaches a saturation point beyond which an increase in the number of walls does not lower the thermal conductivity and transmittance. Although the insulative properties of polymer sheeting are greater than that of glass, it is challenging to have a low thermal conductivity value, high stiffness (i.e., rigidity), and light transmission in polymer sheeting. Thus, there is a continuous demand for further improvement.

Multiwall sheets are commonly designed for structural and thermal insulation applications. As mentioned, lower thermal conductivity values are continually sought in the industry for multiwall sheet applications. A technique to lower thermal conductivity values involves the application of a coating onto a sheet with insulating materials located on the surfaces of the sheet. Coatings, however, can be expensive. Surface texturing can also be used to increase the thermal conductivity value, where features are added on to the surface of the sheet to change the surface area, which in turn increases the conductivity of the sheet. Such steps, however, add cost to the multiwall sheet and increase cycle time by adding an additional manufacturing step, thus decreasing the production rate.

Multiwall sheets that possess lower thermal conductivity values without an increase in cost, mass, or cycle time are desired in the industry.

### BRIEF DESCRIPTION

Disclosed, in various embodiments, are multiwall sheets, methods for making the multiwall sheets, and articles comprising the multiwall sheets.

In an embodiment, a multiwall sheet comprises: walls, wherein the walls include: a first wall; a second wall; and a transverse wall, wherein the first wall, the second wall, and the transverse wall extend longitudinally; and a rib extending between adjacent walls, wherein a layer is formed by two adjacent walls; wherein the layer is filled with a nanoporous foam material; and wherein the multiwall sheet comprises a normalized thermal conductivity value of less than or equal to 1.00 W·m/kg·K.

In another embodiment, a method of making a multiwall sheet comprises: coextruding the multiwall sheet with a nanoporous foam material; wherein the multiwall sheet comprises walls, wherein the walls include: a first wall; a second wall; and a transverse wall, wherein the first wall, the second wall, and the transverse wall extend longitudinally; and a rib extending between adjacent walls, wherein a layer is formed by two adjacent walls; and wherein the layer is filled with a nanoporous foam material during coextrusion.

These and other non-limiting characteristics are more particularly described below.

### BRIEF DESCRIPTION OF THE DRAWINGS

The following is a brief description of the drawings wherein like elements are numbered alike and which are presented for the purposes of illustrating the exemplary embodiments disclosed herein and not for the purposes of limiting the same.

FIG. 1 is a partial, cross sectional front view of a multiwall sheet.

FIG. 2 is a schematic representation of an embodiment of a process for forming nanoporous foam material.

FIG. 3 is a graphical representation of the U value of multiwall sheets compared to the number of walls present and compared to a multiwall sheet comprising nanoporous foam material filled layers.

### DETAILED DESCRIPTION

Disclosed herein, in various embodiments, are multiwall sheets comprising walls, wherein the walls include a first wall, a second wall, and a transverse wall, wherein the first wall, the second wall, and the transverse wall extend longitudinally; and a rib extending between adjacent walls. A layer is formed by two adjacent walls of the multiwall sheet and this open space between the two adjacent walls is filled with a nanoporous foam material such that the multiwall sheet comprises a normalized thermal conductivity value of less than or equal to 1.00 Watt meters per kilogram Kelvin (W·m/kg·K). The transverse wall can extend parallel to the first wall and the second wall, or can extend substantially parallel to the first wall and the second wall (i.e., not completely parallel across the entire length of the first wall and second wall but not intersecting), or can extend longitudinally with the first wall and the second wall.

A significant increase in the thermal insulation properties of a multiwall sheet can be achieved with the use of a nanoporous foam material in a layer of the multiwall sheet. Solid sheets (e.g., comprising polycarbonate) and multiwall sheets can generally be used in structural and thermal insulation applications. It can be desirable for multiwall sheets designed for use in structural applications (e.g., roofing, glazing, and similar applications) to have sufficient thermal and structural performance. Thermal performance and structural performance are important features of a multiwall sheet to reduce energy costs with respect to climate control. The addition of more walls into a multiwall sheet has limitations in decreasing the thermal conductivity value (U value). There is a point where the U value is not affected by the addition of walls (i.e., the sheet becomes saturated by the number of walls and a further increase in the number of walls will not increase the thermal insulation capabilities of the sheet). Generally, the lower the U value, the higher the thermal insulation of the multiwall sheet.

As discussed above, the walls of the multiwall sheets can form layers. For example, any two walls of the multiwall sheet (e.g., first wall and second wall, first wall and transverse wall, transverse wall and second wall; third wall and fourth wall, and so forth) can form a layer. In some embodiments, each layer (i.e., the space between two adjacent walls) of the multiwall sheet can be filled with the nanoporous foam material. In other embodiments, only some of the layers are filled with the nanoporous foam material. For example, in a 10 layer multiwall sheet, the 1st, 3rd, 5th, 7th, and 9th layers could be filled with a nanoporous foam material. Any combination of filled layers is possible (e.g., 2nd, 3rd, 6th, 7th, and 9th; 1st, 2nd, 4th, 5th, 7th, 8th, and 10th; and so forth). It is recognized that a myriad of possibilities for filling the layers of the multiwall sheet exist and can be selected depending upon the particular end use and properties desired of the final product. The multiwall sheets disclosed herein can comprise any number of layers that will provide the desired properties (e.g., thermal insulation). For example, the number of layers can be greater than or equal to 2, specifically, greater than or equal to 5, more specifically, greater than or equal to 10, and even more specifically, greater than or equal to 12.

Also disclosed herein are methods of making a multiwall sheet where a layer of the multiwall sheet is filled with a nanoporous foam material during processing of the multiwall sheet (e.g., during a coextrusion process) or where the multiwall sheet is produced and subsequently a layer therein filled with the nanoporous foam material, where the nanoporous foam material was separately produced. Multiwall sheets produced from such a method or multiwall sheets that are produced and the layers located therein thereafter filled with a nanoporous foam material can possess a U value having a greater than or equal to 70% improvement in the thermal insulation properties as compared to the same multiwall sheet with unfilled layers (i.e., air in the layers).

Nanoporous foam materials possess a thermal conductivity that is lower than air. Filling a layer of a multiwall sheet with nanoporous foam material reduces the heat flow through the multiwall sheet, which also increases the thermal insulation capabilities of the multiwall sheet. Filling layers of the multiwall sheet as described herein generally refers to packing of the nanoporous foam material into the space between two adjacent walls of the multiwall sheet. For example, a layer can be packed with greater than or equal to 50% of the nanoporous foam material, specifically, greater than or equal to 75% packed with the nanoporous foam material, more specifically, greater than or equal to 85% packed with the nanoporous foam material, even more specifically, greater than or equal to 95% packed with the nanoporous foam material, still more specifically, greater than or equal to 99% packed with the nanoporous foam material, and even yet more specifically, 100% packed with the nanoporous foam material.

In one embodiment, a multiwall sheet is produced (e.g., a multiwall sheet is extruded) and thereafter a layer filled with a nanoporous foam material. In one embodiment, the nanoporous foam material is in the form of pellets or beads (e.g., nanometer-sized beads), which is added to a layer of a multiwall sheet after formation of the multiwall sheet. When the nanoporous foam material is in the form of small pellets or beads, integration of the nanoporous foam material in a layer is more easily facilitated. In another embodiment, the multiwall sheet and the nanoporous foam material are coextruded and the nanoporous foam material fills a layer of the multiwall sheet during coextrusion.

Exemplary nanoporous foam material is described in commonly assigned U.S. Pat. No. 7,838,108 B2, which is incorporated by reference. For example, a process comprising contacting a polymer with a foaming agent where the polymer comprises particles having an average particle size of 10 nanometers to 10 millimeters can make the nanoporous foam material. The process can be implemented in an extruder. The nanoporous foam material can be prepared without using high pressures, e.g., by using a low temperature to saturate the polymer particles with the foaming agent. During the contacting step, the foaming agent (e.g., gas molecules) diffuses into the polymer to form a single phase (e.g., “homogeneous phase”). The extrusion technique may be performed at a low temperature, such as below ambient temperature (e.g., below about 25° C.). In one embodiment, polymer feed can be taken and saturated with carbon dioxide gas as 0° C. which leads to the formation of the homogeneous phase. Next, the homogeneous phase is fed into an extruder having a die to produce the nanoporous foam material. Generally, descriptions herein of “nanometer” sized include any and all dimensions measuring from 1 nanometer to less than 1,000 nanometers.

As disclosed herein, the term “average particle size” as applied to the polymer feed used for making the nanoporous foam material refers to the average size of the particles measured per unit volume. Particle sizes can be 10 nanometers to 10 millimeters, specifically, 10 nanometers to 1 millimeter, and more specifically, 10 nanometers to 100 micrometers. In one embodiment, a polymer having an average particle size of 1 micrometer can be used to obtain a nanoporous foam material having an average pore size of 400 nanometers. Average pore size refers to the diameter of the foam cells, which is generally represented as a frequency/cell size distribution plot. In an embodiment, the nanoporous foam material has an average pore size of 25 nanometers to 200 nanometers, specifically 50 nanometers to 100 nanometers.

A more complete understanding of the components, processes, and apparatuses disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

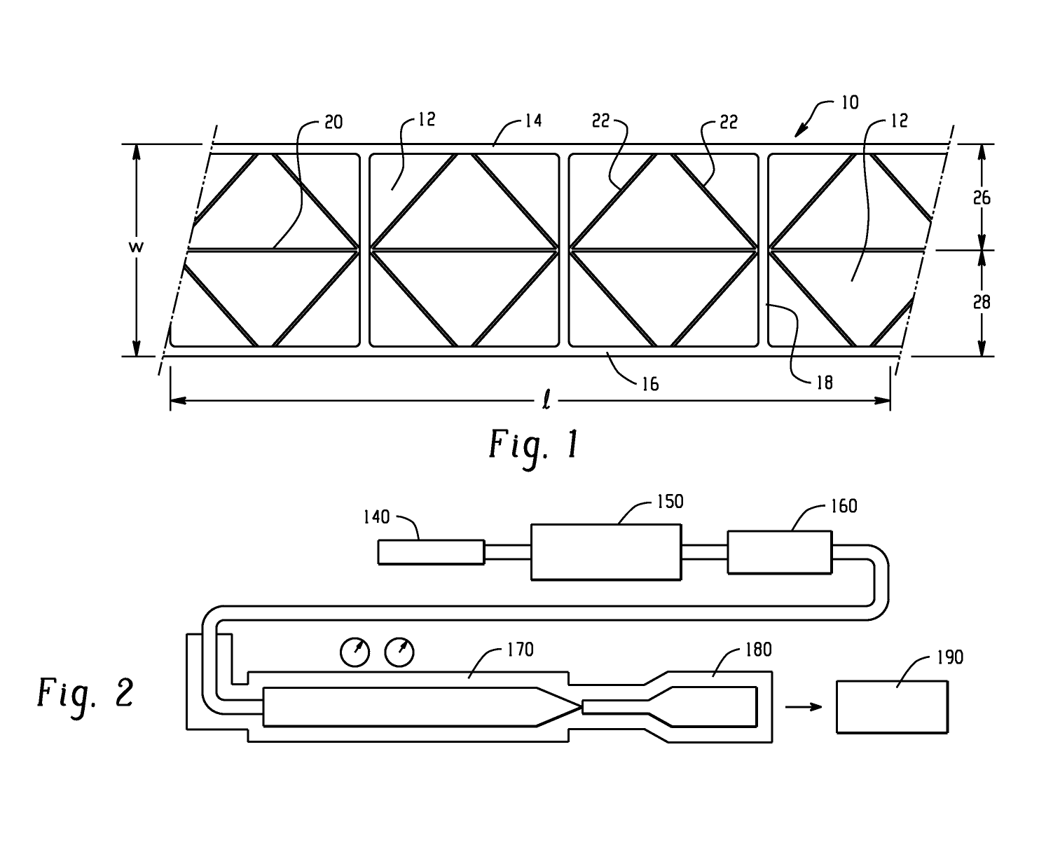

FIG. 1 illustrates a five wall multiwall sheet 10 comprising walls where the walls include a first wall 14, a second wall 16, a transverse wall 20, and a rib 18 extending between the first wall 14 and the second wall 16. The first wall 14 and the second wall 16 are the outermost walls of the multiwall sheet 10. In one embodiment, the transverse wall 20 can extend longitudinally the length of the first wall 14 and the second wall 16. In another embodiment, the transverse wall 20 can be parallel to the first wall 14 and the second wall 16 or, the transverse wall 20 can be substantially parallel to the first wall 14 and the second wall 16 (e.g., not completely parallel across the entire length of the first wall 14 and the second wall 16, but not intersecting the first wall 14 or the second wall 16 either, accommodating for slight variations in the orientation during processing). Layers 26, 28 can be formed by the open space located between adjacent walls, e.g., layer 26 can be formed by first wall 14 and transverse wall 20, while layer 28 can be formed by transverse wall 20 and second wall 16. Also located within the open space are, optionally, dividers 22, which are non-parallel and non-perpendicular to the walls and the rib 18. The dividers 22 form cavities 12 in the layers 26, 28. The width (w) of the multiwall sheet and length (l) of the multiwall sheet are also illustrated in FIG. 1.

In the multiwall sheet 10 illustrated in FIG. 1, the various layers (26, 28, etc.) of the multiwall sheet 10 can be filled with a nanoporous foam material as previously described, e.g., to increase the thermal conductivity of the multiwall sheet 10. In the embodiment illustrated in FIG. 1, layer 26 can be filled with a nanoporous foam material, or layer 28 can be filled with a nanoporous foam material, or both layer 26 and layer 28 can be filled with a nanoporous foam material.

The number of cavities 12 present in the layers 26, 28 can vary and can generally be any value that will further increase the thermal insulation capabilities and/or the structural integrity and/or other desired properties of the multiwall sheet 10. For example, the number of cavities present in a layer 26, 28 can be greater than or equal to 2, specifically, greater than or equal to 10, yet more specifically, greater than or equal to 15, and even yet more specifically, greater than or equal to 20. In some embodiments, the number of cavities 12 in the multiwall sheet 10 can be greater than or equal to 75, more specifically, greater than or equal to 100, and even more specifically, greater than or equal to 120. Not to be limited by theory, it is believed that an increased number of layers 26, 28 filled with a nanoporous foam material in the multiwall sheet 10 provides a lower U value for the multiwall sheet 10 and thus, increased thermal insulation properties for the multiwall sheet 10.

In one embodiment of the process for producing a nanoporous foam material, illustrated in FIG. 2, polymer feed 140 having the desired particle size is taken and saturated with carbon dioxide gas at 0° C. (reference numeral 150), which leads to the formation of the “homogeneous phase” 160. Next, the “homogeneous phase” 160 is fed into extruder 170 comprising die 180 to produce the nanoporous foam material 190.

To produce nanoporous foam material by an extrusion technique, it is desirable that the total time taken for forming the “homogeneous phase” material from gas impregnated polymer particles and the time spent by the “homogeneous phase” material in a polymer processor (e.g., an extruder), is less than the time taken for the foaming agent to diffuse out of the polymer particles. The total time can be regarded as a “residence time”, which can be 0.5 to 0.9 times the time taken for diffusion of foaming agent out of the polymer particles.

The methods described above can be implemented in a batch, semi-batch, or a continuous manner. Continuous methods are desirable since they can allow for better process control and production of nanoporous foam material having a relatively more uniform and higher quality, such as for example, a narrow pore size distribution having an average pore size of less than or equal to about one time the standard deviation. In another embodiment, the polymer foams disclosed herein have an average pore size standard deviation that is less than or equal to about 10 percent of the average pore size. The term “average pore size” has been described previously herein.

The polymer foams disclosed herein may have a high unit density that in an embodiment is greater than 10⁹ units per cubic centimeter, in another embodiment is 10¹² to 10¹⁸ units per cubic centimeter, and in still another embodiment is 10¹⁵ to 10¹⁸ units per cubic centimeter. As disclosed herein, the term “unit” is defined as a void cavity that makes up the foam. The units may comprise an “open unit structure”, a “closed unit structure”, or combinations thereof. An “open unit structure” is defined as a void cavity that is open at one or more sides. Open unit structures may connect to other open or closed unit structures. A “closed unit structure” is defined as a void cavity with no opening. A closed unit structure may or may not be present on the surface of a nanoporous foam material. If present, the skin of the closed unit may form a part of the foam surface.

As disclosed herein, the term “foaming agent” is defined as a chemical agent that is used to foam a polymer. The foaming agent (e.g., blowing agent) can be a solid, a liquid, non-supercritical, gas, or a supercritical foaming agent. Foaming agents that may be used include inorganic agents, organic agents, and other chemical agents. Suitable inorganic blowing agents include carbon dioxide, nitrogen, argon, water, air, nitrogen, and inert gases such as helium, xenon, and argon. Organic agents include aliphatic hydrocarbons having 1-9 carbon atoms, aliphatic alcohols having 1-3 carbon atoms, and fully and partially halogenated aliphatic hydrocarbons having 1-4 carbon atoms. Aliphatic hydrocarbons include methane, ethane, propane, n-butane, isobutane, n-pentane, isopentane, neopentane, as well as combinations comprising at least one of the foregoing. Aliphatic alcohols include methanol, ethanol, n-propanol, and isopropanol. Fully and partially halogenated aliphatic hydrocarbons include fluorocarbons, chlorocarbons, and chlorofluorocarbons. Examples of fluorocarbons include methyl fluoride, perfluoromethane, ethyl fluoride, 1,1-difluoroethane (HFC-152a), 1,1,1-trifluoroethane (HFC-143a), 1,1,1,2-tetrafluoro-ethane (HFC-134a), pentafluoroethane, difluoromethane, perfluoroethane, 2,2-difluoropropane, 1,1,1-trifluoropropane, perfluoropropane, dichloropropane, difluoropropane, perfluorobutane, perfluorocyclobutane, and combinations comprising at least one of the foregoing. Partially halogenated chlorocarbons and chlorofluorocarbons include methyl chloride, methylene chloride, ethyl chloride, 1,1,1-trichloroethane, 1,1-dichloro-1-fluoroethane (HCFC-141b), 1-chloro-1,1-difluoroethane (HCFC-142b), chlorodifluoromethane (HCFC-22), 1,1-dichloro-2,2,2-trifluoroethane (HCFC-123), 1-chloro-1,2,2,2-tetrafluoroethane (HCFC-124), and combinations comprising at least one of the foregoing. Fully halogenated chlorofluorocarbons include trichloromonofluoromethane (CFC-11), dichlorodifluoromethane (CFC-12), trichlorotrifluoroethane (CFC-113), 1,1,1-trifluoroethane, pentafluoroethane, dichlorotetrafluoroethane (CFC-114), chloroheptafluoropropane, and dichlorohexafluoropropane. Other chemical agents include azodicarbonamide, azodiisobutyronitrile, benzenesulfonhydrazide, 4,4-oxybenzene sulfonyl-semicarbazide, p-toluene sulfonyl semi-carbazide, barium azodicarboxylate, N,N′-dimethyl-N,N′-dinitrosoterephthalamide, trihydrazino triazine, and combinations comprising at least one of the foregoing. The foaming agent can comprise one or more of the above chemical agents.

In an embodiment, the foaming agent can be carbon dioxide, air, nitrogen, argon, gaseous hydrocarbons, and combinations comprising at least one of the foregoing. The foaming agent can be a material such as solid carbon dioxide, liquid carbon dioxide, gaseous carbon dioxide, or supercritical carbon dioxide, as well as combinations comprising at least one of the foregoing.

Solid state foaming techniques can be applied to continuous foaming processes, such as those described herein, for producing nanoporous foam material. The polymer can be in a flowing state in the extruder, but modeling the physics of the foaming process can be used to control the nucleation density and cell size distribution of the nanoporous foam material. For example, a combination of physical blowing agent (e.g., a blowing agent that can achieve foaming with any chemical change as opposed to a chemical foaming agent, which generate a foaming gas by a chemical reaction), a surface tension modifier, application of a pulsating pressure, and a temperature quench step can be used, e.g., to potentially increase unit density to about a billion units per cubic centimeter in the resulting nanoporous foam material. In an embodiment, the extruder screw and the die can be designed in such a way so as to maximize the pressure drop in the extruder to saturate the polymer feed with the foaming agent e.g., to maximize unit density in the nanoporous foam material. Alternative ways of saturating the polymer feed can also be used to maximize unit density in the resulting nanoporous foam material. The polymer feed used to make the nanoporous foam material and the multiwall sheet can be formed from the same or different polymeric materials, such as thermoplastics and thermoplastic blends.

Possible thermoplastic resins that can be employed to form the nanoporous foam material and to form the multiwall sheet include, but are not limited to, oligomers, polymers, ionomers, dendrimers, copolymers such as block copolymers, graft copolymers, star block copolymers, random copolymers, and combinations comprising at least one of the foregoing. Examples of such thermoplastic resins include, but are not limited to, polycarbonates (e.g., polycarbonate-polybutadiene blends, blends of polycarbonate, copolyester polycarbonates), polystyrenes (e.g., copolymers of polycarbonate and styrene), polyimides (e.g., polyetherimides), acrylonitrile-styrene-butadiene, polyphenylene ether-polystyrene blends, polyalkylmethacrylates (e.g., polymethylmethacrylates), polyesters (e.g., copolyesters, polythioesters), polyolefins (e.g., polypropylenes and polyethylenes, high density polyethylenes, low density polyethylenes, linear low density polyethylenes), polyamides (e.g., polyamideimides), polyarylates, polysulfones (e.g., polyarylsulfones, polysulfonamides), polyphenylene sulfides, polytetrafluoroethylenes, polyethers (e.g., polyether ketones, polyether etherketones, polyethersulfones), polyacrylics, polyacetals, polybenzoxazoles (e.g., polybenzothiazinophenothiazines, polybenzothiazoles), polyoxadiazoles, polypyrazinoquinoxalines, polypyromellitimides, polyquinoxalines, polybenzimidazoles, polyoxindoles, polyoxoisoindolines (e.g., polydioxoisoindolines), polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyls (e.g., polyvinyl ethers, polyvinyl thioethers, polyvinyl alcohols, polyvinyl ketones, polyvinyl halides, polyvinyl nitriles, polyvinyl esters, polyvinylchlorides), polysulfonates, polysulfides, polyureas, polyphosphazenes, polysilazzanes, polysiloxanes, and combinations comprising at least one of the foregoing.

More particularly, the thermoplastic material used to form the nanoporous foam material and to form the multiwall sheet can include, but is not limited to, polycarbonate resins (e.g., Lexan* resins, commercially available from SABIC Innovative Plastics IP B.V.), polyphenylene ether-polystyrene resins (e.g., Noryl* resins, commercially available from SABIC Innovative Plastics IP B.V.), polyetherimide resins (e.g., Ultem* resins, commercially available from SABIC Innovative Plastics IP B.V.), polybutylene terephthalate-polycarbonate resins (e.g., Xenoy* resins, commercially available from SABIC Innovative Plastics IP B.V.), copolyestercarbonate resins (e.g. Lexan* SLX resins, commercially available from SABIC Innovative Plastics IP B.V.), and combinations comprising at least one of the foregoing resins. Even more particularly, the thermoplastic resins can include, but are not limited to, homopolymers and copolymers of a polycarbonate, a polyester, a polyacrylate, a polyamide, a polyetherimide, a polyphenylene ether, or a combination comprising at least one of the foregoing resins. The polycarbonate can comprise copolymers of polycarbonate (e.g., polycarbonate-polysiloxane, such as polycarbonate-polysiloxane block copolymer), linear polycarbonate, branched polycarbonate, end-capped polycarbonate (e.g., nitrile end-capped polycarbonate), and combinations comprising at least one of the foregoing, for example a combination of branched and linear polycarbonate.

In other embodiments, the thermoplastic material used to form the nanoporous foam material and to form the multiwall sheet can include, but are not limited to, an acrylic resin, a polycarbonate, a polyolefin, a polyester, a polyvinyl chloride, or combinations comprising at least one of the foregoing. Non-limiting examples of semi-crystalline thermoplastic polymers which can be used to form the nanoporous foam material or the multiwall sheet include polybutylene terephthalate, polyphenylene sulfides, polyetheretherketones (PEEK), polyetherketones (PEK), phthalamides (PPA), polyetherketoneketones (PEKK), and high temperature nylons.

If desired, the thermoplastic material used to form the nanoporous foam material and to form the multiwall sheet can also contain thermosetting polymers. Examples of thermosetting polymers are polyurethanes, natural rubber, synthetic rubber, epoxy, phenolic, polyesters, polyamides, polyimides, silicones, and the like, as well as combinations comprising at least one of the foregoing.

The nanoporous foam material and the resin used to form the multiwall sheet can include various additives ordinarily incorporated into polymer compositions of this type, with the proviso that the additive(s) are selected so as to not significantly adversely affect the desired properties of the sheet, in particular, thermal insulation. Such additives can be mixed at a suitable time during the mixing of the components for forming nanoporous foam material or the multiwall sheet. Exemplary additives include impact modifiers, fillers, reinforcing agents, antioxidants, heat stabilizers, light stabilizers, ultraviolet (UV) light stabilizers, plasticizers, lubricants, mold release agents, antistatic agents, colorants (such as carbon black and organic dyes), surface effect additives, anti-ozonants, thermal stabilizers, anti-corrosion additives, flow promoters, pigments, dyes radiation stabilizers (e.g., infrared absorbing), flame retardants, and anti-drip agents. A combination of additives can be used, for example a combination of a heat stabilizer, mold release agent, and ultraviolet light stabilizer. In general, the additives are used in the amounts generally known to be effective. The total amount of additives (other than any impact modifier, filler, or reinforcing agent) is generally 0.001 wt % to 5 wt %, based on the total weight of the composition of the multiwall sheet, or based on the total weight of the composition of the nanoporous foam material.

The thermoplastic polymer is generally fed to the throat of the extruder along with any other desired additive(s). The additives may also be fed to the extruder in masterbatch form. The feed material may be produced by melt blending the polymer feed material and other desired additives and then forming in a single step using devices such as single and twin-screw extruders, Buss kneaders, roll mills, Waring blenders, Henschel mixers, helicones, Banbury mixers, or the like, or combinations of the at least one of the foregoing melt blending devices. The nanoporous foam material and the multiwall sheet can be coextruded to form a multiwall sheet filled with a nanoporous foam material.

In addition to conductivity, the polymeric material can be chosen to exhibit sufficient impact resistance such that the sheet is capable of resisting breakage (e.g., cracking, fracture, and the like) caused by impact (e.g., hail, birds, stones, and so forth). Therefore, polymers exhibiting an impact strength greater than or equal to about 7.5 foot-pounds per square inch, ft-lb/in² (4.00 joules per square centimeter, J/cm²), or more specifically, greater than about 10.0 ft-lb/in² (5.34 J/cm²) or even more specifically, greater than or equal to about 12.5 ft-lb/in² (6.67 J/cm²) are desirable, as tested per ASTM D-256-93 (Izod Notched Impact Test). Further, desirably, the polymer has ample stiffness to allow for the production of a sheet that can be employed in applications wherein the sheet is generally supported and/or clamped on two or more sides of the sheet (e.g., clamped on all four sides), such as in greenhouse applications comprising tubular steel frame construction. Sufficient stiffness herein is defined as polymers comprising a Young's modulus (e.g., modulus of elasticity) that is greater than or equal to about 1×10⁹ N/m², more specifically 1×10⁹ to 20×10⁹ N/m², and still more specifically 2×10⁹ to 10×10⁹ N/m².

The nanoporous foam material comprises a thermal conductivity of less than or equal to 0.060 W/m·K, specifically, less than or equal to 0.025 W/m·K, more specifically, less than or equal to 0.010 W/m·K, and even more specifically, less than or equal to 0.001 W/m·K. The nanoporous foam material can have one or more desirable properties including, but not limited to, optical transparency (e.g., 10% to 90% light transmission), and superior structural, thermal, and electrical properties at a lower weight. The nanoporous foam material can have an average pore size of 10 nanometers to 500 nanometers.

Thermal conductivity characterizes the heat transfer through the central part of the glazing or multiwall sheet as measured in Watts per square meter Kelvin (W/m²K). More specifically, the U value is the amount of thermal energy that passes across one square meter of the multiwall sheet at a temperature difference between both sides of the sheet and is commonly referred to as thermal insulation or thermal conductivity. The U value can be calculated as per the International Standard Organization (ISO) test number 10077-2:2003(E) with a temperature difference between both sides of the sheet of 20 Kelvins (K). The U value or thermal conductivity is calculated by the following formula (I):

$$\frac{1}{U} = \frac{1}{{h}_{i}} + \frac{t}{k} + \frac{1}{{h}_{e}} \qquad ( I )$$

where hₑ is the external heat transfer coefficient, hᵢ is the internal heat transfer coefficient, t is the material thickness, and k is thermal conductivity. The numerical thermal calculation is carried out using a two dimensional heat transfer analysis conforming to EN ISO 10211-1:1995(E). The numerical thermal calculation can also be performed using a standard finite element method for 2D and/or 3D models. For the purposes of this calculation, it is assumed that principle heat flow in the section tested is perpendicular to a plane parallel to the external and internal surfaces. It is also assumed that the emissivity of the surfaces adjoining the cavities is 0.9 per ISO 10077-2:2003(E).

Thermal conductivity of multiwall sheets (U) is the value that characterizes the heat transfer through the central part of the sheet and steady state density of heat transfer rate per temperature difference between the ambient temperatures on each side. The external heat transfer coefficient, hₑ, in W/m²K, is a function of the wind speed, v, near the multiwall sheet given by the following formula (II):

hₑ10.0+4.1v. (II)

A hₑ value of 24 W/m²K is used for the purpose of comparing glazing U values. The internal heat transfer coefficient, hᵢ in W/m²K, is a function of the wind speed, v, near the glazing given by the following formula (III):

hᵢ=hᵣ+h_{c}. (III)

In the equation, hᵣ is the radiation conductance and h_{c} is the convective conductance. For conventional vertical glass surfaces and free convection, hᵢ=4.4+3.3=7.7 W/m²K. This value is standardized for the purpose of comparing the multiwall sheet U value. Both the external heat transfer coefficient and the internal heat transfer coefficient are calculated using ISO 10292:1994(E).

The heat flow rate in the cavities is represented by an equivalent thermal conductivity, λ_{eq}. This equivalent thermal conductivity includes the heat flow by conduction, convection, and radiation and also depends upon the geometry of the cavity and any adjacent materials. For unventilated cavities, equivalent thermal conductivity is given by the following formula (IV):

λ_{eq}=d/Rₛ, (IV)

where Rₛ, the convective heat transfer coefficient is represented by the following formula (V):

Rₛ=1/(hₐ+hᵣ) (V)

and hₐ, the radiation conductance, is represented by the following formula (VI):

hₐ=max{C₁/d;C₂ΔT^{1/3}}, (VI)

where d is the dimension of the cavity in the direction of the heat flow, C₁ is a constant equal to 0.0235 W/m·K and C₂ is a constant equal to 0.71 W/m² K^{4/3}. If no emissivity of the surfaces and other information is available, then ε1 is equal to ε2 and both are equal to 0.9 as described above. T is the temperature and is equal to 283 K, and hᵣ, which is the convective conductance, is represented by the following formula (VII):

hᵣ=C₄(1+(√1+(d/b)²)−d/b), (VII)

where C₄ is a constant equal to 2.11 W/m²K.

The equivalent density of the sheet (measured in kilograms per cubic meter (kg/m³)) is one method of comparing various multiwall sheets (e.g., for comparing sheets with varying weights and gauges). Equivalent density is calculated by dividing the weight per unit surface area of the sheet by the sheet thickness. The multiwall sheets disclosed herein can have a normalized thermal U Value (measured in Watt meters per kilogram Kelvin (W·m/kg·K)) that is equal to the U value (W/m²K) divided by the equivalent density of the sheet multiplied by 100. This normalized U value can be used for a comparison of properties of multiwall sheets independent of the thickness, shape, or configuration.

The thermal conductivity value (U) for a given sheet is limited by a saturation point with the number of walls present in the sheet for a given weight of the material. Air has a thermal conductivity value of about 0.025 W/m·K at room temperature (e.g., about 25° C.) and atmospheric pressure. It can be difficult to achieve thermal conductivity values near or less than air because at a certain number of walls the multiwall sheet becomes saturated and any additional number of walls added will not decrease the thermal conductivity value any further.

The multiwall sheets as disclosed herein are capable of having a normalized linear thermal conductivity value less than or equal to 1.0 W/m·K, specifically, less than or equal to 0.80 W/m·K, more specifically, less than or equal to 0.75 W/m·K, more specifically still, less than or equal to 0.70 W/m·K, and even more specifically, less than or equal to 0.68 W/m·K. The multiwall sheets disclosed herein having a layer filled with a nanoporous foam material are capable of having a normalized linear thermal conductivity value 50% less than or equal to the same multiwall sheets but without nanoporous foam material, specifically, 60% less than or equal to the same multiwall sheets but without nanoporous foam material, more specifically, 65% less than or equal to the same multiwall sheets but without nanoporous foam material, and even more specifically, 70% less than or equal to the same multiwall sheets but without nanoporous foam material.

The total thickness (t) of the multiwall sheet is generally less than or equal to 100 millimeters (mm), more specifically, less than or equal to 55 mm, still more specifically, less than or equal to 32 mm, but generally greater than or equal to 6 mm. In one embodiment, the multiwall sheet has a thickness of 16 mm. In one another embodiment, the multiwall sheet has a thickness of 10 mm.

The multiwall sheet can comprise a length (l) (see FIG. 1) capable of providing sufficient spatial area coverage for the intended use (e.g., as a roofing, sheeting, or similar products). For example, the length of the multiwall sheet can generally be less than or equal to 2000 mm, more specifically, less than or equal to 1800 mm, still more specifically, less than or equal to 1250 mm, but generally greater than or equal to 400 mm. In one embodiment, the multiwall sheet has a width of 1000 mm.

The multiwall sheet can comprise a width (w) (see FIG. 1) capable of providing sufficient stiffness for the intended use (e.g., as a roofing, sheeting product, or similar product). For example, the width of the multiwall sheet can generally be less than or equal to 100 mm, more specifically, less than or equal to 55 mm, still more specifically, less than or equal to 32 mm, but generally greater than or equal to 6 mm. In one embodiment, the multiwall sheet has a width of 16 mm. When assembled, the multiwall sheet can be exposed to a variety of forces caused by snow, wind, rain, hail, and the like. The sheet is desirably capable of withstanding these forces without failing (e.g., buckling, cracking, bowing, and so forth). The specific dimensions of the multiwall sheet can be chosen so that the multiwall sheet can withstand these forces.

A method of making the multiwall sheet can comprise coextruding a multiwall sheet with the nanoporous foam material such that the nanoporous foam material fills the layers of the multiwall sheet as the sheet is formed (e.g., the layer and cavity formation and the foaming are accomplished simultaneously). The coextrusion process combines the flow of molten polymer (e.g., thermoplastic polymer) with a gas saturated polymer (e.g., nanoporous foam material). Such a process can lead to non-uniform foam morphology and a change in sheet structure, so the process parameters for producing the nanoporous foam material should be within 10% of the extrusion process parameters for producing the multiwall sheet. In another embodiment, a multi-step process is disclosed, in which the multiwall sheet and nanoporous foam material are produced separately. In a subsequent step, a layer of the multiwall sheet is then filled with nanoporous foam to form an integral article.

In embodiments where the multiwall sheet is produced and the layers are subsequently filled with the nanoporous foam material (optionally in the form of small pellets or beads), the multiwall sheet can be formed from other polymer processing methods, such as extrusion or injection molding, if produced as a unitary structure. Continuous production methods, such as extrusion, generally offer improved operating efficiencies and greater production rates than non-continuous operations, such as injection molding. Specifically, a single screw extruder can be employed to extrude a polymer melt (e.g., polycarbonate, such as Lexan*, commercially available from SABIC Innovative Plastics). The polymer melt and nanoporous foam material are fed to a profile die capable of forming an extrudate having the cross-section of the desired multiwall sheet. The extruded multiwall sheet travels through a sizing apparatus (e.g., vacuum bath comprising sizing dies) and is then cooled below its glass transition temperature (e.g., for polycarbonate, about 297° F. (147° C.)).

After the sheet has cooled, it can be cut to the desired length utilizing an extrusion cutter, such as an indexing in-line saw. Once cut, the multiwall sheet can be subjected to secondary operations before packaging. Exemplary secondary operations can comprise annealing, printing, attachment of fastening members, trimming, further assembly operations, and/or any other desirable processes. The size of the extruder, as measured by the diameter of the extruder's screw, is based upon the production rate desired and calculated from the volumetric production rate of the extruder and the cross-sectional area of the panel. The cooling apparatus can be sized (e.g., length) to remove heat from the extrudate in an expedious manner without imparting haze.

Haze can be imparted when a polymer (e.g., polycarbonate) is cooled rapidly. Therefore, the cooling apparatus can operate at warmer temperatures (e.g., greater than or equal to about 100° F. (39° C.), or more specifically, greater than or equal to 125° F. (52° C.), rather than colder temperatures (e.g., less than 100° F. (39° C.), or more specifically, less than or equal to about 75° F. (24° C.)) to reduce hazing. If warmer temperatures are employed, the bath length can be increased to allow ample time to reduce the extrudate's temperature below its glass transition temperature. The size of the extruder, cooling capacity of the cooling apparatus, and cutting operation can be capable of producing the multiwall sheet 10 at a rate of greater than or equal to about 5 feet per minute. However, production rates of greater than about 10 feet per minute, or even greater than about 15 feet per minute can be achieved if such rates are capable of producing surface features that comprise the desired attributes.

As discussed, coextrusion methods can also be employed for the production of the multiwall sheet. Coextrusion can be employed to supply different polymers to any portion of the multiwall sheet's geometry to improve and/or alter the performance of the panel and/or to reduce raw material costs. In one embodiment, a coextrusion process can be employed to fill the layers with the nanoporous foam material as the multiwall sheet is being extruded. The pressure across length of the multiwall sheet (e.g., across each layer) as it is being extruded should be balanced to enable the walls to withstand the force applied when the nanoporous foam material is introduced. Optionally, a gas (e.g., air) can be blown into the multiwall sheet as the nanoporous foam material is being coextruded to assist in preventing the walls of the multiwall sheet from collapsing upon the introduction of the nanoporous foam material. One skilled in the art would readily understand the versatility of the process and the myriad of applications in which coextrusion can be employed in the production of multiwall sheets.

The multiwall sheet is further illustrated by the following non-limiting examples. All of the following examples were based upon simulations unless specifically stated otherwise.

### EXAMPLES

### Example 1

A multiwall sheet with nanoporous foam filled layers is compared to the same multiwall sheet (e.g., same length, width, and thickness, same materials for the multiwall sheet) without filled layers. The multiwall sheets are polycarbonate and polycarbonate based nanoporous foam material is used. To calculate the U value, simulation software was used and the multiwall sheets were numerically tested according to ISO 10077-2:2003. The boundary conditions used in the tests were an external heat transfer coefficient, hₑ, of 25 W/m²K, an internal heat transfer coefficient, hᵢ, of 7.7 W/m²K, and a temperature difference across the sheet of 20 K. Table 1 illustrates the results obtained from the samples tested. Comparative Samples 1 to 5 (C1 to C5) are multiwall sheets with empty layers (e.g., filled with air), while Sample 1 comprises a 5 wall multiwall sheet with the layers filled with nanoporous foam material. In Sample 1, all the layers are filled with the nanoporous foam material. The multiwall sheets in C1 to C5 and Sample 1 were 16 mm thick with vertical ribs dispersed across the sheet with a spacing of 16 mm between the vertical ribs.

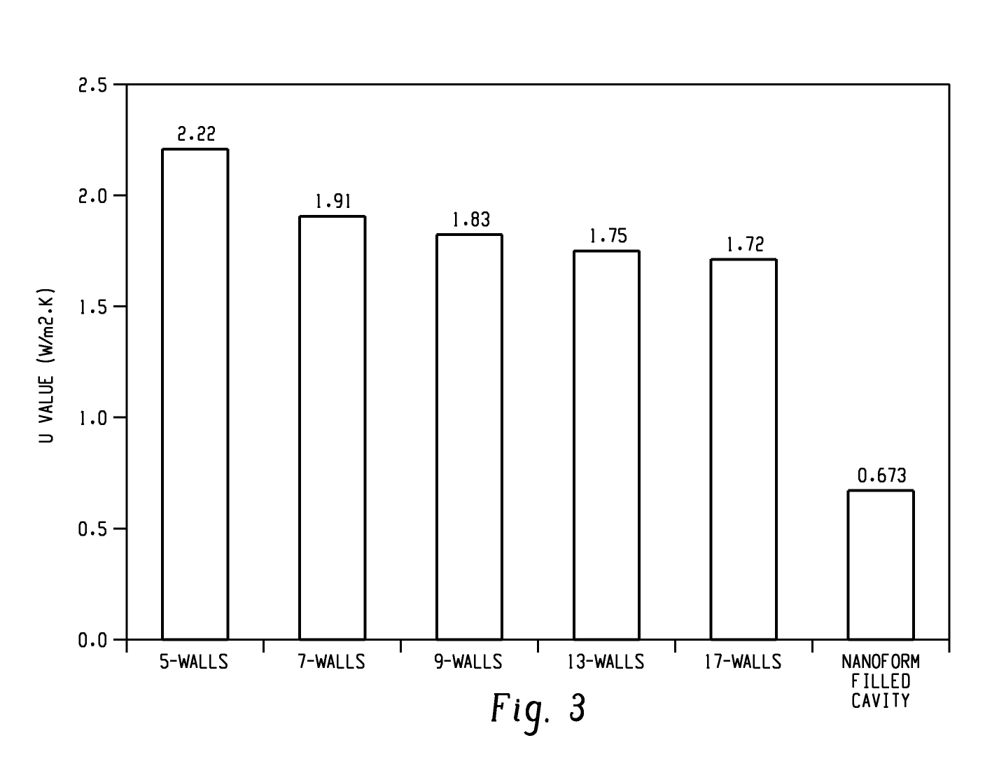

FIG. 3 illustrates a graphical representation of the U values compared to the number of walls present in the multiwall sheet. As can be seen from Table 1 and FIG. 2, even with 17 walls (i.e., C5), the U value is still more than double that of the multiwall sheet having nanoporous foam filled layers and only 5 walls (Sample 1). In other words, the thermal insulation of Samples C1 to C5, where the layers are empty, but the number of walls are increased is much less than Sample 1, where the layers are filled with a nanoporous foam material during coextrusion of the multiwall sheet. Table 1 also displays the normalized thermal U value of samples C1 to C5 and 1. The normalized U value is calculated as previously described, i.e., the normalized U value is equal to the U value divided by the equivalent density of the sheet multiplied by 100. The multiwall sheet equivalent density is 171 kg/m³. The nanoporous foam equivalent density is 1 kg/m³ to 200 kg/m³. An equivalent density of 40 kg/m³ is used for this example.

TABLE 1

| | | | | | Normalized |
|---|---|---|---|---|---|
| | Composition | Number | | | Thermal U |
| Sample | of Multiwall | of | U Value | Percentage | Value |
| No. | Sheet | Walls | (W/m²K) | Reduction | (W · m/kg · K) |
| C1 | layers empty | 5 | 2.22 | N/A | 1.296 |
| C2 | layers empty | 7 | 1.91 | 14% | 1.115 |
| C3 | layers empty | 9 | 1.83 | 18% | 1.069 |
| C4 | layers empty | 13 | 1.75 | 21% | 1.022 |
| C5 | layers empty | 17 | 1.72 | 23% | 1.004 |
| 1 | layers filled | 5 | 0.673 | 70% | 0.319 |
| | with | | | | |
| | nanoporous | | | | |
| | foam | | | | |

Sample 1 is similar in composition to C1 in that both are multiwall sheets comprising 5 walls. The layers of Sample 1 are filled with a nanoporous foam material, while the layers of C1 are empty (e.g., filled with air). As seen from Table 1, Sample 1 has a 70% reduction in the U value, equating to a 70% improvement in the thermal insulation of the multiwall sheet compared to C1. For example, the normalized thermal U value of the multiwall sheet can be less than or equal to 1.00 W·m/kg·K, specifically, less than or equal to 0.75 W·m/kg·K, more specifically, less than or equal to 0.70 W·m/kg·K, even more specifically, less than or equal to 0.68 W·m/kg·K, still more specifically, less than or equal to 0.50 W·m/kg·K, yet more specifically, less than or equal to 0.40 W·m/kg·K, and still yet more specifically, less than or equal to 0.35 W·m/kg·K. It can be seen from Table 1 that an increase in the number of walls from 5 to 17 with empty layers has only a slight improvement in the thermal insulation capabilities of the multiwall sheet. The improvement in thermal insulation (i.e., percentage reduction in the U value) with the multiwall sheets disclosed herein can be greater than or equal to 50%, specifically, greater than or equal to 55%, more specifically, greater than or equal to 60, even more specifically, greater than or equal to 65%, and still more specifically, greater than or equal to 70%.

The multiwall sheets disclosed herein illustrate that lower U values can be achieved by utilizing a nanoporous foam material in a layer of a multiwall sheet. Additionally, lower U values can be achieved through the combination of nanoporous foam material with an increased number of walls in the heat flow direction in the design of a multiwall sheet. It was unexpectedly discovered that the utilization of a nanoporous foam material in a layer of a multiwall sheet after the sheet has been formed gives a reduction in the U value and a normalized U value that is three times less than without the nanoporous foam material.

In one embodiment, a multiwall sheet comprises: walls, wherein the walls include: a first wall; a second wall; and a transverse wall, wherein the first wall, the second wall, and the transverse wall extend longitudinally; and a rib extending between adjacent walls, wherein a layer is formed by two adjacent walls; wherein the layer is filled with a nanoporous foam material; and wherein the multiwall sheet comprises a normalized thermal conductivity value of less than or equal to 1.00 W·m/kg·K.

In the various embodiments: (i) the multiwall sheet comprises a normalized thermal conductivity value of less than or equal to 0.75 W·m/kg·K; and/or (ii) the multiwall sheet comprises a normalized thermal conductivity value of less than or equal to 0.50 W·m/kg·K; and/or (iii) the nanoporous foam material is contained within nanometer-sized beads; and/or (iv) the layer is filled greater than or equal to 95% with nanoporous foam material; and/or (v) the layer is filled greater than or equal to 99% with nanoporous foam material.

In one embodiment, a method of making a multiwall sheet comprises: coextruding the multiwall sheet with a nanoporous foam material; wherein the multiwall sheet comprises walls, wherein the walls include: a first wall; a second wall; and a transverse wall, wherein the first wall, the second wall, and the transverse wall extend longitudinally; and a rib extending between adjacent walls, wherein a layer is formed by two adjacent walls; wherein the layer is filled with a nanoporous foam material during coextrusion.

In the various embodiments, (i) the multiwall sheet comprises a normalized thermal conductivity value of less than or equal to 1.00 W·m/kg·K; and/or (ii) the multiwall sheet comprises a normalized thermal conductivity of less than or equal to 0.75 W·m/kg·K; and/or (iii) the multiwall sheet comprises a normalized thermal conductivity value of less than or equal to 0.50 W·m/kg·K and/or (iv) the layer is filled greater than or equal to 95% with nanoporous foam material.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A multiwall sheet, comprising:
walls, wherein the walls include:
a first wall;
a second wall; and
a transverse wall, wherein the first wall, the second wall, and the transverse wall extend longitudinally; and
a rib extending between adjacent walls, wherein a layer is formed by two adjacent walls;
wherein the layer is filled with a nanoporous foam material; and
wherein the multiwall sheet comprises a normalized thermal conductivity value of less than or equal to 1.00 W·m/kg·K.

2. The multiwall sheet of claim 1, wherein the multiwall sheet comprises a normalized thermal conductivity value of less than or equal to 0.75 W·m/kg·K.

3. The multiwall sheet of claim 1, wherein the multiwall sheet comprises a normalized thermal conductivity value of less than or equal to 0.50 W·m/kg·K.

4. The multiwall sheet of claim 1, wherein the nanoporous foam material is contained within nanometer-sized beads.

5. The multiwall sheet of claim 1, wherein the layer is filled greater than or equal to 95% with nanoporous foam material.

6. The multiwall sheet of claim 1, wherein the layer is filled greater than or equal to 99% with nanoporous foam material.

7. A method of making a multiwall sheet, comprising:
coextruding a multiwall sheet with a nanoporous foam material;
wherein the multiwall sheet comprises walls, wherein the walls include:
a first wall;
a second wall; and
a transverse wall, wherein the first wall, the second wall, and the transverse wall extend longitudinally; and
a rib extending between adjacent walls, wherein a layer is formed by two adjacent walls;
wherein the layer is filled with a nanoporous foam material during coextrusion.

8. The method of claim 7, wherein the multiwall sheet comprises a normalized thermal conductivity value of less than or equal to 1.00 W·m/kg·K.

9. The method of claim 8, wherein the multiwall sheet comprises a normalized thermal conductivity of less than or equal to 0.75 W·m/kg·K.

10. The method of claim 8, wherein the multiwall sheet comprises a normalized thermal conductivity value of less than or equal to 0.50 W·m/kg·K.

11. An article made by the method of claim 7.

12. The method of claim 7, wherein the layer is filled greater than or equal to 95% with nanoporous foam material.

13. The method of claim 7, wherein the layer is filled greater than or equal to 99% with nanoporous foam material.
